(19) United States
(12) Patent Application Publication
(10) Pub. No.: US 2013/0162467 A1
(43) Pub. Date: Jun. 27, 2013

(54) SYSTEM AND METHOD FOR BROADCASTING GOLF EVENTS USING SATELLITE IMAGERY

(71) Applicant: Erik Winther, Birkerod (DK)

(72) Inventor: Erik Winther, Birkerod (DK)

(73) Assignee: GOLF METRIC, INC., Palo Alto, CA (US)

(21) Appl. No.: 13/677,498

(22) Filed: Nov. 15, 2012

Related U.S. Application Data
(60) Provisional application No. 61/563,291, filed on Nov. 23, 2011.
(60) Provisional application No. 61/559,986, filed on Nov. 15, 2011.

(51) Int. Cl. G01S 19/19; G01S 19/42

(52) U.S. Cl. CPC G01S 19/19; G01S 19/42
USPC 342/357.25; 342/357.57

(57) ABSTRACT

This disclosure provides a golf-stroke recording system, method, and apparatus. For example, the system includes a location sensing component, a processor, and a golf-stroke recording application executable by the processor, which is configured to track the movement of a player's golf ball as the golf ball traverses along the golf course, and then present the tracked movement of the golf ball on images associated with aerial views of the particular golf course on which the player is playing.

### CROSS-REFERENCE TO RELATED APPLICATIONS

This application claims the benefit of priority to U.S. Provisional Application No. 61/559,986, filed on Nov. 15, 2012, entitled METHOD AND APPARATUS FOR RECORDING GOLF STROKES, and to U.S. Provisional Application No. 61/563,291 filed on Nov. 23, 2011, entitled SYSTEM AND METHOD FOR BROADCASTING GOLF EVENTS USING SATELLITE IMAGERY, the entire contents of both of which are incorporated herein by reference for all purposes.

### FIELD OF THE INVENTION

The disclosure relates to sporting events, and, more particularly, to a system and method for broadcasting golfing events using satellite imagery.

### BACKGROUND

When playing competitive golf, players are responsible for keeping score of themselves as well as their markers (or opponents). This usually involves noting the number of strokes a player took to complete a particular hole at the end of the hole. Oftentimes, players will not communicate their recorded scores to one another until at the end of the round. As a result, if one of the players made a mistake in noting the number of strokes at a particular hole, there is no way for the players to determine which of the players noted down the correct score. Furthermore, having a conversation regarding the score after each hole may be time consuming and cumbersome.

Moreover, at present, there is no way for a golf player to share his score and more specifically, the manner in which he played a round of golf. For instance, the player may like to share that he scored an eagle on the third hole by hitting a massive drive onto the middle of the fairway, or if he had a bad day, to show that he kept landing shots in the bunker.

Accordingly, a need exists for a method and system of recording a player's round of golf such that the player can analyze his round and share aspects of his round with others.

### SUMMARY

Technologies disclosed herein relate to methods, apparatus and systems for tracking a player's golf strokes during a round of golf to assist in keeping score as well as providing a platform through which the player may share aspects of his round with others.

According to one aspect of the present disclosure, a golf-stroke recording system comprises a location sensing component, a processor, and a golf-stroke recording application executable by the processor, which is configured to track the movement of a player's golf ball as the golf ball traverses along the golf course, and then present the tracked movement of the golf ball on images associated with aerial views of the particular golf course on which the player is playing.

According to another aspect of the disclosure, a system for broadcasting data related to a golfing event comprises: A) a first computing device comprising: i) a processor, ii) a memory coupled to the processor, ii) a network interface coupled to the processor and memory, iv) a location module, responsive to user-initiated commands, for acquiring GPS satellite data relevant to a ball position at a time the initiated command is received and for storing GPS satellite data associated with the ball position in the memory, v) an image retrieval module, operably coupled to the network interface and the location module, for retrieving from a network accessible source of satellite images, an image associated with the ball position and for storing the image in memory, vi) a display engine, coupled to the memory, for generating a scorecard comprising a visual representation of at least one ball position relative to the associated image and for storing the scorecard in memory and for presenting the scorecard to a user, vii) communication module, coupled to the memory and the network interface, for transmitting the visual representation to another process over a communication network, and B) a second computing device accessible over the communication network and configured for receiving and storing the scorecard from the first computing device. In one embodiment, the second computing device comprises a server apparatus having a memory configured for storing a plurality of different scorecards and communication module, coupled to the memory and a network interface, for transmitting the one of the plurality of scorecards stored in memory to a third computing device upon a request therefore. In another embodiment, the second computing device is similar to the first computing device.

According to another aspect of the disclosure, an apparatus for broadcasting data related to a golfing event comprises: A) a processor, B) a network interface coupled to the processor, C) a memory coupled to the processor and the network interface, the memory configured for storing a plurality of different scorecards, the scorecards comprising data identifying any of a golfer, a golf course, a hole within the golf course, number of ball positions for a given hole, a golf club for a shot, and golfer profile data; and D) a communication module, coupled to the memory and the network interface, for receiving a request from a remote process identifying one of the plurality of scorecards and for transmitting at least a portion of the identified scorecard to the remote process over a communication network.

According to yet another aspect of the invention, in a computing apparatus having a processor coupled to a memory and a network interface operably coupling the processor and memory to a communication network, a method for broadcasting data related to a golfing event comprises: A) receiving and storing into the memory a user-defined profile from each of a plurality of golfer processes, the plurality of profiles each identifying a golfer, network access information, and golfer privacy preferences; B) receiving and storing into memory a scorecard associated with one of the plurality of golfers, the scorecard comprising data identifying any of a golf course, a hole within the golf course, number of ball positions for a given hole, and a golf club for a shot; and D) receiving a request from a remote process for a scorecard associated with one of the plurality of golfers; E) determining from the golfer privacy preferences in the golfer profile associated with the requested scorecard if the scorecard is publishable; and F) transmitting the identified scorecard to the remote process over a communication network if the scorecard is publishable. In one embodiment, the request from the remote process identifies the user associated with the remote process and wherein (E) further comprises: (E1) comparing the golfer privacy preferences in the golfer profile associated with the requested scorecard to determine if the identified requester is allowed access to the requested scorecard.

### BRIEF DESCRIPTION THE DRAWINGS

The present disclosure will be more completely understood through the following description, which should be read in conjunction with the drawings in which:

FIG. 1A illustrates a conceptual block diagram of a golf-stroke recording system in accordance with embodiments of the present disclosure;

FIG. 1B illustrates conceptually a hybrid network diagram illustrating the network infrastructure in accordance with embodiments of the present disclosure;

FIGS. 2A and 2B illustrate a conceptual flowchart of an initialization process of the golf-stroke recording application and corresponding conceptual screenshots in accordance with embodiments of the present disclosure;

FIGS. 3A and 3B illustrate a conceptual flowchart of a golf-stroke recording process and corresponding conceptual screenshots in accordance with embodiments of the present disclosure;

FIGS. 4A and 4B illustrate a conceptual flowchart of an alternate initialization process of the golf-stroke recording application and corresponding conceptual screenshots in accordance with embodiments of the present disclosure;

FIGS. 5A and 5B illustrate a conceptual flowchart of an alternate golf-stroke recording process and corresponding conceptual screenshots in accordance with embodiments of the present disclosure;

FIGS. 6A and 6B illustrate a conceptual flowchart of an alternate golf-stroke recording process and corresponding conceptual screenshots in accordance with embodiments of the present disclosure;

FIGS. 7A and 7B illustrate a conceptual flowchart of a scorecard synchronization process and corresponding conceptual screenshots in accordance with embodiments of the present disclosure;

FIG. 8 is a conceptual block diagram illustrating the device in accordance with embodiments of the present disclosure;

FIG. 9A illustrates a conceptual block diagram of a golf-stroke recording device in accordance with embodiments of the present disclosure;

FIG. 9B illustrates a conceptual block diagram of a broadcasting architecture in accordance with embodiments of the present disclosure; and

FIG. 10 is a conceptual data structure including entries associated with a sample scorecard in accordance with embodiments of the present disclosure.

### DETAILED DESCRIPTION

The present disclosure will be more completely understood through the following description, which should be read in conjunction with the drawings. In the description, like numbers refer to similar elements within various embodiments of the present disclosure. The skilled artisan will readily appreciate that the methods, apparatus and systems described herein are merely exemplary and that variations can be made without departing from the spirit and scope of the disclosure.

Technologies disclosed herein relate to methods, apparatus and systems for tracking a player's golf strokes during a round of golf to assist in keeping score as well as providing a platform through which the player may share aspects of his round with others. By way of the present disclosure, a player may be able to track his golf play one stroke at a time by recording location coordinates associated with the ball after each stroke. In some embodiments, the user may manually record the location of the ball by pressing buttons on a device, while in alternate embodiments, the device may be able to automatically identify the location of the ball based on the player's actions. In addition, the device may be able to record additional information regarding a stroke by either receiving additional data about the lie of the ball, existing weather conditions, time and date information, amongst others. The device may then present the recorded information by plotting the movement of the golf ball as an overlay of aerial images of the golf course such that ball location relative to hazards on the course may be identified. Moreover, the present disclosure also provides teachings for facilitating the entry of a scorecard and for maintaining a historical record of a player's performance at various golf courses over time. In this way, a player will be able to access previous performances and track improvements in scores over time. At the same time, the player may be able to make his performances accessible to the public such that the public may track the player's performance during a particular round. In some embodiments, the public may have access to the progress of multiple players on a golf course in real-time.

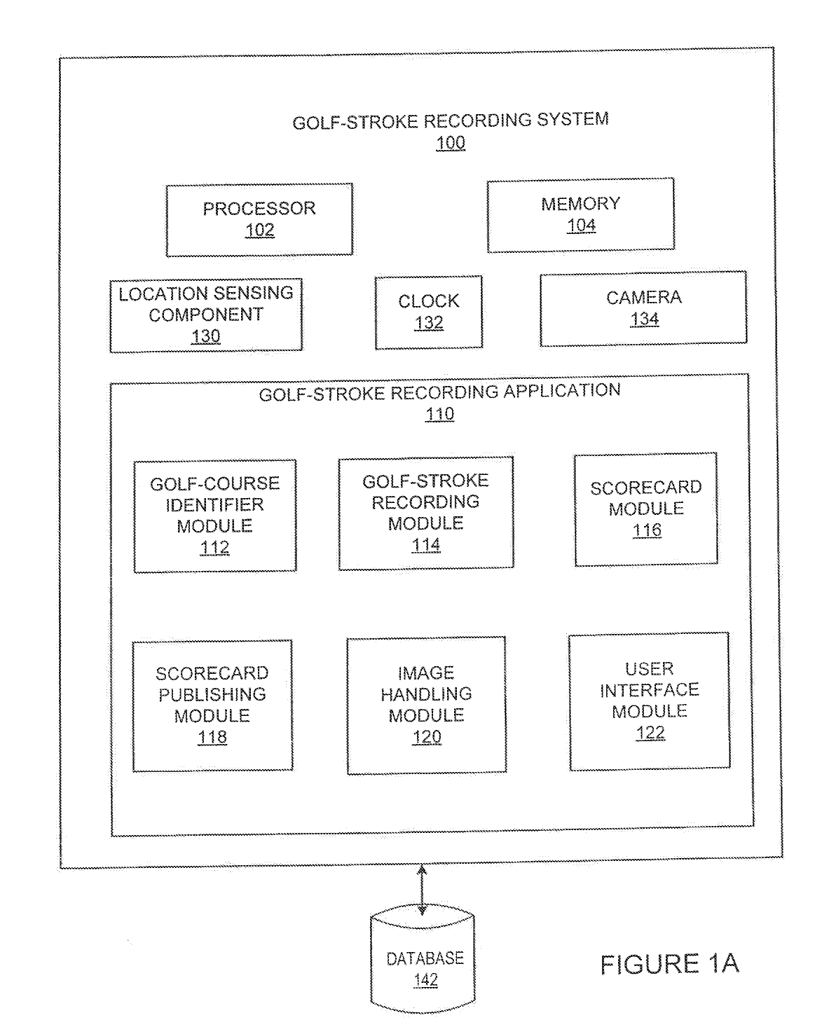

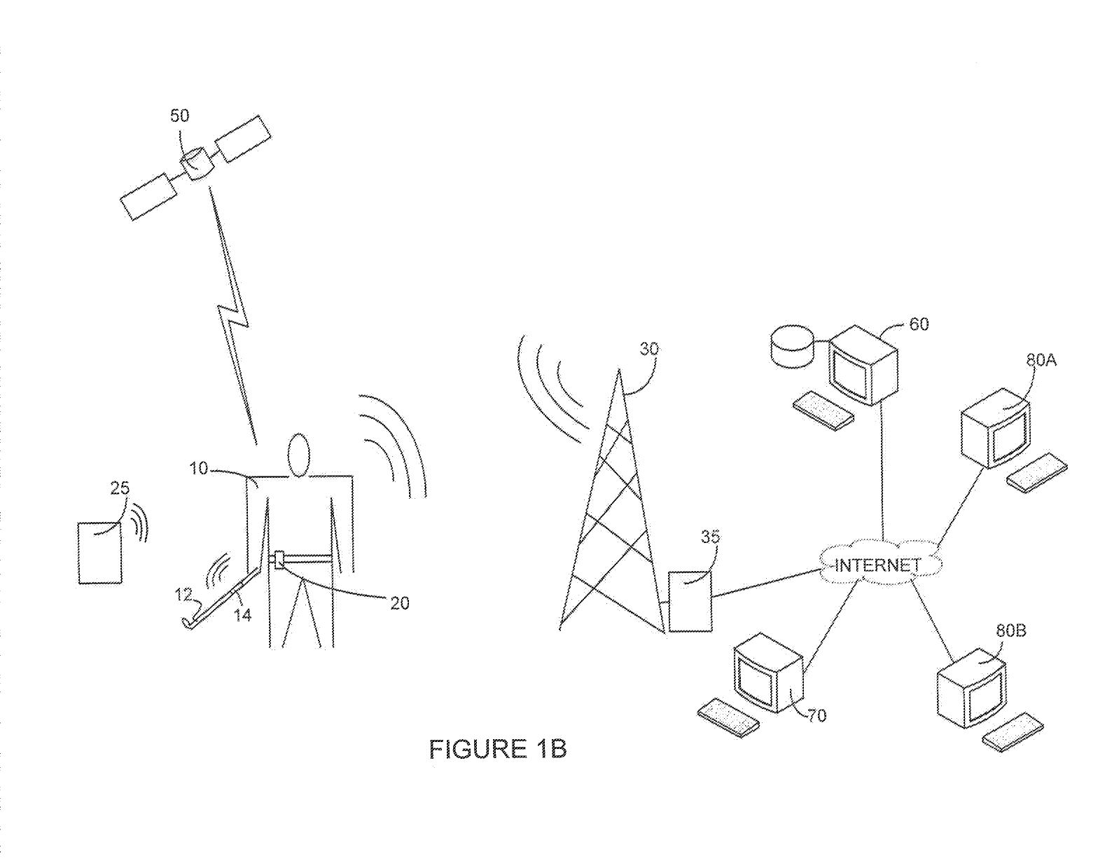

Referring now to the drawings, FIG. 1 illustrates a conceptual block diagram of a golf-stroke recording system according to various embodiments of the present disclosure. The golf-stroke recording system 100 includes a processor 102, a memory 104 that is coupled to the processor 102 and a golf-stroke recording application 110 that includes one or more software modules for performing various operations described herein. In particular, the software modules may include computer-executable instructions that may be executed by the processor 102. It should be appreciated that the golf-stroke recording system 100 may be a standalone physical device or a part of an existing hardware and software platform, such as a mobile phone. In such embodiments, the golf-stroke recording system 100 may utilize aspects of the mobile phone, including but not limited to, global positioning system (GPS) functionality or cellular signal reception, to determine the geographic location of the player and/or a golf ball being used by the player. In embodiments where the golf-stroke recording system 100 is rendered as a standalone product, the golf-stroke recording system 100 may also have hardware components and accompanying software components in addition to the golf-stroke recording application 110. In particular, the golf-stroke recording system may include a location sensing component 130, including but not limited to a global positioning system sensor for identifying the location of a player, a clock 132 for recording a time and date, and in some embodiments, a camera 134 for recording images taken by the player as the player or player's ball traverses the golf course.

According to embodiments, the golf-stroke recording application 110 may include a golf-course identifier module 112, a golf-stroke recording module 114, a scorecard module 116, and a scorecard publishing module 118. In addition, the golf-stroke recording application 110 may include an image handling module 120 for handling images taken by the golfer during the round of golf.

The golf-course identifier module 112 may be configured to identify a particular golf-course on which a player is to play a round of golf. In various embodiments, the golf-course identifier module 112 may utilize the location sensor component to receive location data, and based on the location data, perform a lookup search on a golf-course database 142 to determine the golf-course at which the player is located. The golf-course database 142 may be stored on the same device on which the golf-stroke recording system 110 is operating, or may be stored at a remote location accessible via a network. According to some embodiments, the golf-course database may include images of golf courses, including aerial view images of the entire golf course as well as aerial images of an entire hole, including the teeing box and the green on which the flag is located. The images may be provided by a third party image database, including but not limited to, Google Maps, illustrated in FIG. 1B as server 70.

Upon identifying the golf-course, the golf-course identifier module 112 may be configured to retrieve images of the golf-course. the player may be able to access images pertaining to a particular hole. In various embodiments, the golf-course identifier module 112 may be able to identify a particular hole that the player is on based on the location of the player. Alternatively, images of holes may be accessible as a sequence as the player moves from the first hole to subsequent holes all the way to the eighteenth hole. It should be appreciated that the hole images may be tagged and accessed by the user by searching for images pertaining to a particular hole number.

The golf-stroke recording module 114 may provide an interface to the user to record the position of a ball prior to the ball being hit, As will be shown in the user-interface images described herein, the player may indicate whether the ball is on a fairway, tee, or green by recording the shot with a first button or graphic element, which, in one embodiment, may have a green color. Alternatively, the player may indicate whether the ball is not on a fairway, tee, or green by recording the shot with a second button which, in one embodiment, may have a red color. In some embodiments, the player may also record golf-strokes using one of the first and second buttons based on the lie of the ball. A bad lie, such as if the ball is in the bunker or the rough may be recorded using the second button. The player may record the stroke using the first button if the lie is easy even if the ball is not on the fairway, green, or tee. In this way, when the round is complete and the player's round is analyzed, a person analyzing the player's round will also be informed of whether the player had a good lie or a bad lie.

In some embodiments, a player may utilize the camera 134 to capture an image of the lie. As such, the player may take an image of the lie and indicate the stroke with which it is associated. The image handling module 120 may then process the image such that the player or another person analyzing the player's round may be able to access the image of the lie. In various embodiments, the image handling module 120 may place a pin next to the position of the ball that may be accessed by a user (the player or someone else analyzing the player's round), such that when the pin is accessed, an image associated with the particular location is shown. As described above, the image may be an image of the lie, but may also be an image of anything the player wishes to capture, including but not limited to, the view of the flag from the ball, the proximity of the ball to other objects, and the like.

In some embodiments, the golf-stroke recording module 114 may be configured to monitor the movement of the player using the location sensor component. In addition, the golf-stroke recording module 114 may be configured to alert the player to record the score after the golf-stroke recording module 114 determines that the player has approached the ball after his last stroke. In some embodiments, the golf-stroke recording module 114 may be able to determine that the player has approached the ball by tracking the movement of the player. If the player has walked a considerable distance and then stops around a general vicinity along the path between a teeing location and a corresponding hole location, the golf-stroke recording module may be able to determine that the player has approached his ball. As such, the golf-stroke recording module 114 may then alert the user to record his stroke. It should be appreciated that the golf-stroke recording module may be intelligent enough to identify the location of the ball without requiring the player to manually record his stroke. In such embodiments, the golf-stroke recording system may work most accurately if it is in close proximity of the player, such as in the player's pocket. In some embodiments, the system 100 may be configured with additional hardware and software components, such as accelerometers, gyroscopes, and microphones, to detect that the player has made a stroke. By identifying that a stroke has been made, the golf-stroke recording module 114 may record the location at which the stroke was detected by the system 100. Specifically, the system 100 may be able to detect that a stroke was made by detecting rotation of the player's hip, vibrations through the player's arm, accompanied with the detection of a noise that has characteristics similar to a ball being struck by a club.

The scorecard module 116 may be configured to automatically fill out the player's scorecard. In various embodiments, the scorecard module 116 may utilize the golf-stroke recording module 114 to count the number of strokes a player takes to complete a hole. In addition, the golf-stroke recording module 114 may further keep track of a marker's score by interfacing with the marker's device. In some embodiments, the player's device and the marker's device may be configured to interface with one another such that their scores can be shared, facilitating the process of filling out the opponent's scorecard.

The scorecard publishing module 118 may be configured to publish a player's scorecard to a central server, from where a printout may be taken and provided to the player for verification. In addition, the scorecard publishing module 118 may provide the player and other users to review a particular player's scorecard, and access data associated with the scorecard, including but not limited to, the strokes recorded by the player, an indication of the lie of each stroke, any images associated with the round of golf, time and date information, amongst others. In some embodiments, weather conditions may also be provided, including but not limited to, wind speed, brightness, humidity, and the like. This information may be captured by a hardware component associated with the system 100 or by gathering data from an online weather reporting service or application running in the background of the golf-stroke recording application 110. Weather reporting services may not be as accurate and may not include all sorts of information including exact wind speeds, but may still provide insights on the weather conditions during the round of golf.

It should be appreciated that the application 110 may further include a user interface module 122 that presents the data captured by the golf-stroke recording application 110 to the user in a simple, clear, and easy to use manner. In various embodiments, and as will be described with respect to the screenshots provided herein, the location of a ball may be presented on an aerial image of the golf course. Flag locations and teeing areas may also be identified and displayed. By presenting the movement of the ball on an image of the actual golf-course, users may gather a lot more information than existing methods, where only the number of strokes per hole is provided, without any context as to where the ball had landed throughout the hole.

Referring now to FIG. 1B a conceptual a hybrid network diagram illustrating the network infrastructure utilized by the golf-stroke recording application in accordance with embodiments of the present disclosure is illustrated. A golfer 10 with a device 20 records the location of the lie of the most recent stroke as described herein. In the illustrative environment, the golf-stroke recording system 100 in device 20 may utilize aspects of the mobile phone, including but not limited to, the functionality of the global positioning system (GPS) 50 or cellular signal transceiver system 30, to determine the geographic location of the player and/or a golf ball being used by the player. This process continues with each stroke and each hole until the system 100 is able to connect with a cell tower of system 30 or other wireless communication transceiver which is connected to a wide area network, illustrated as Internet 40. Thereafter, the scorecard publishing module 118 transmits a player's scorecard to a central server 60, which, if the golfer has chosen to make his score public, will push the scorecard data out to other golfers/users 80A-B having similar systems 100. Similarly, the golfer may receive the scorecard of the other golfers/users 80A-B in a similar manner.

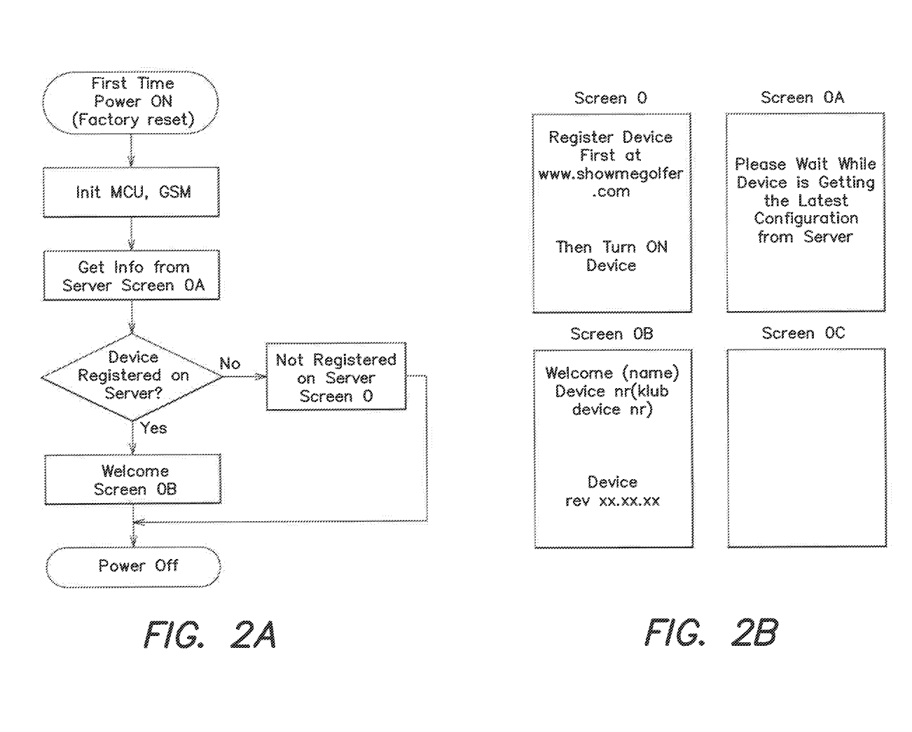

Referring now to FIGS. 2A and 2B, a conceptual flowchart illustrating an initialization process of the golf-stroke recording application and corresponding conceptual screenshots are shown. In particular, the golf-stroke recording application 110 may determine whether a device on which the golf-stroke recording application 110 is running is a device registered on a central server that hosts scorecard information.

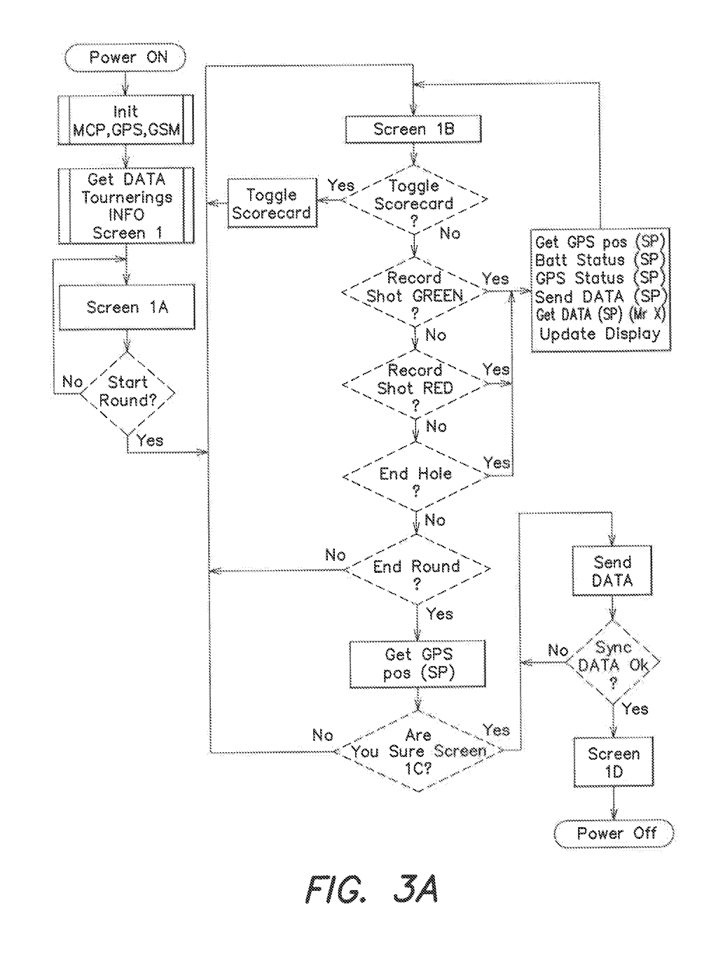

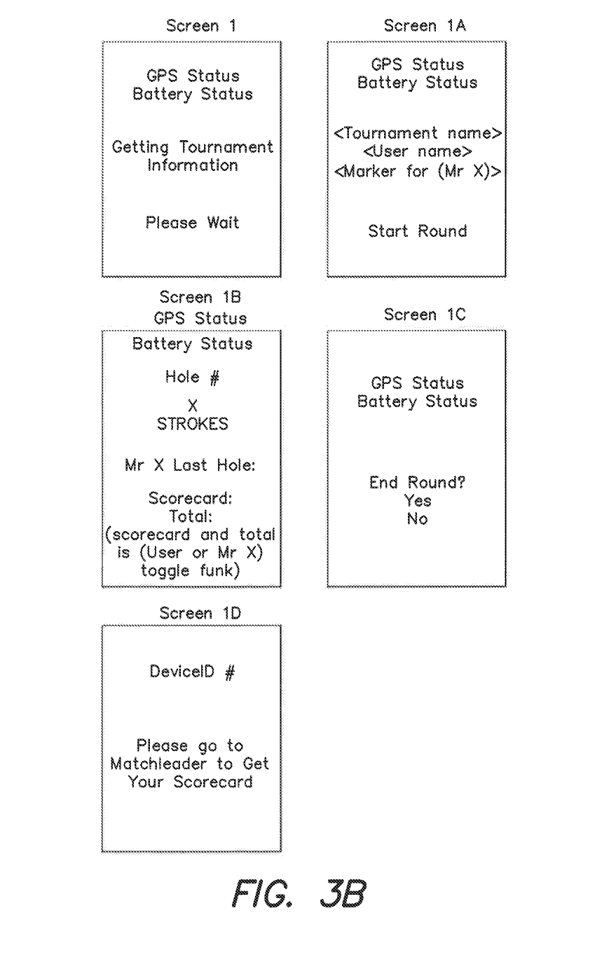

Referring now to FIGS. 3A and 3B, a conceptual flowchart illustrating a golf-stroke recording process and corresponding conceptual screenshots are shown. In particular, the process includes presenting options to the player and receiving input from the player for recording golf strokes as the player traverses a hole and an entire round. In addition, the process includes utilizing location sensing functionality to identify the location of a player and/or the player's ball, and converting the received data into a scorecard that is sent to a centralized hosting server.

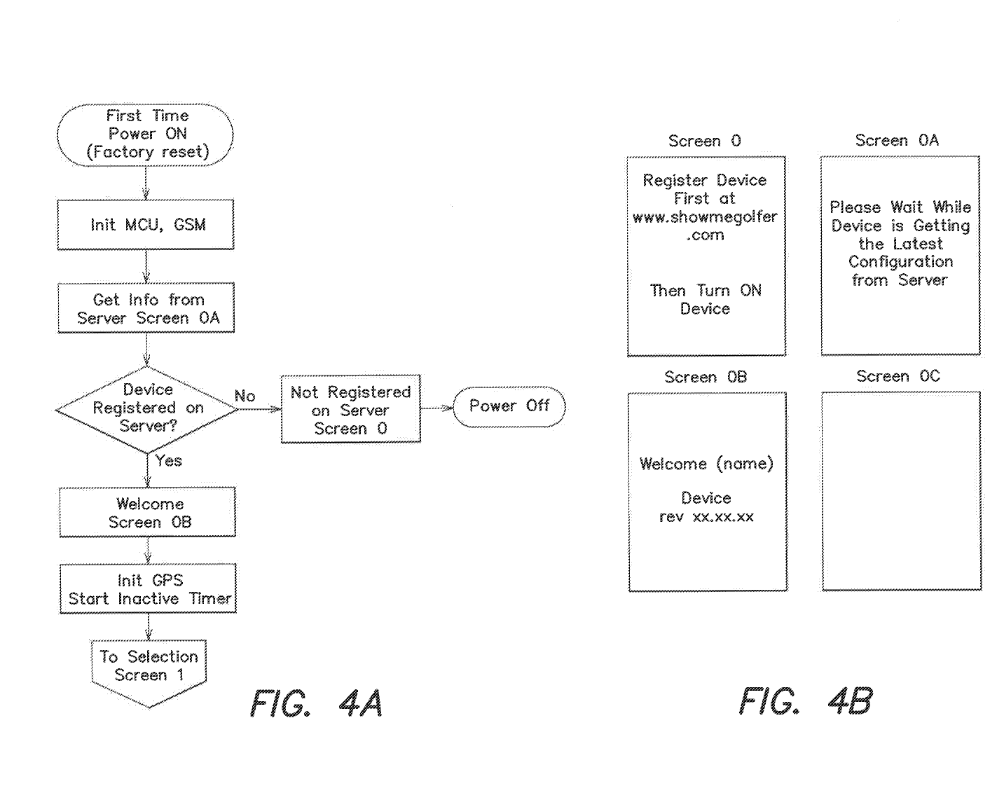

Referring now to FIGS. 4A and 4B, a conceptual flowchart illustrating an alternate initialization process of the golf-stroke recording application and corresponding conceptual screenshots are shown. In particular, the golf-stroke recording application 110 may determine whether a device on which the golf-stroke recording application 110 is running is a device registered on a central server that hosts scorecard information.

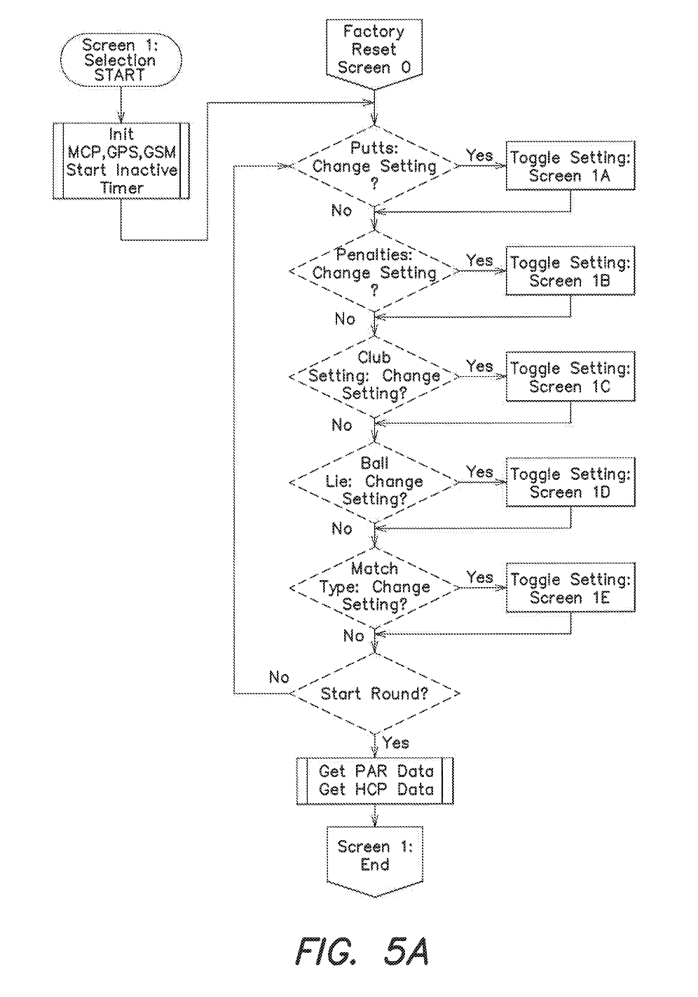

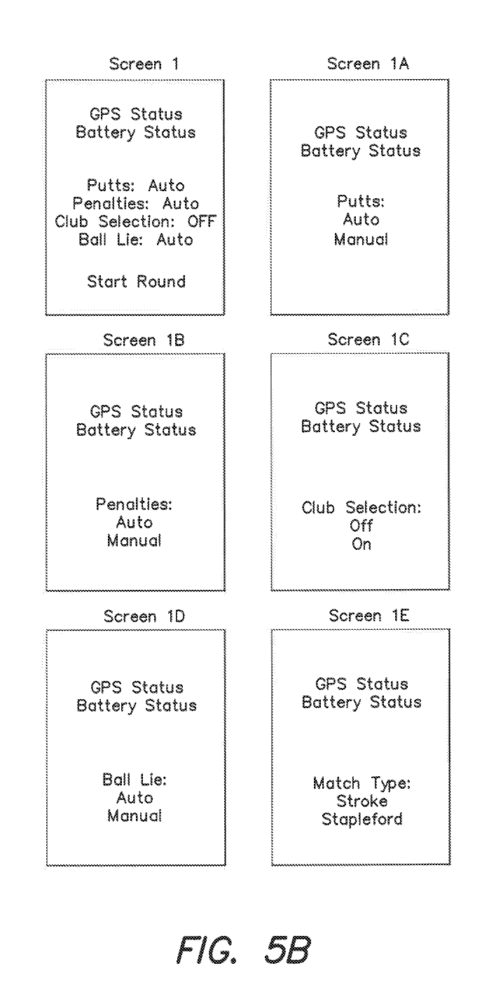

Referring now to FIGS. 5A and 5B, a conceptual flowchart illustrating an alternate golf-stroke recording process and corresponding conceptual screenshots are shown. In particular, the process includes presenting options to the player to record specific golf strokes as the player traverses a hole and an entire round, including but not limited to, putts and penalties. In addition, the process is configured to allow a player to provide information associated with the club being used to hit a particular stroke as well as information related to the lie of the ball. Further, specific information related to the type of match and opponents may also be received from the player.

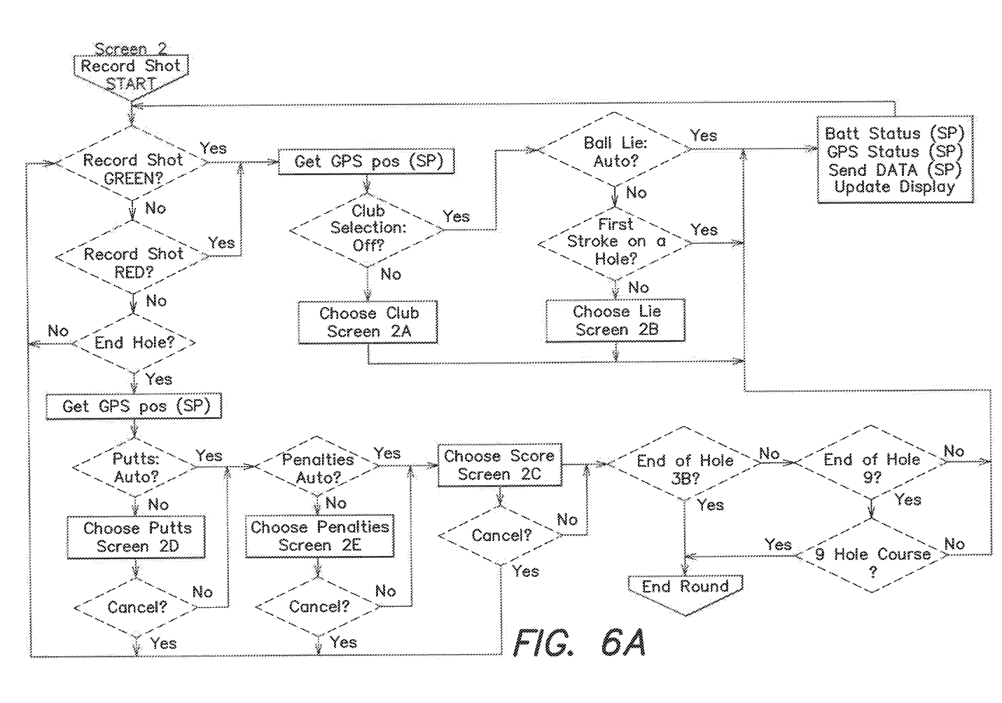

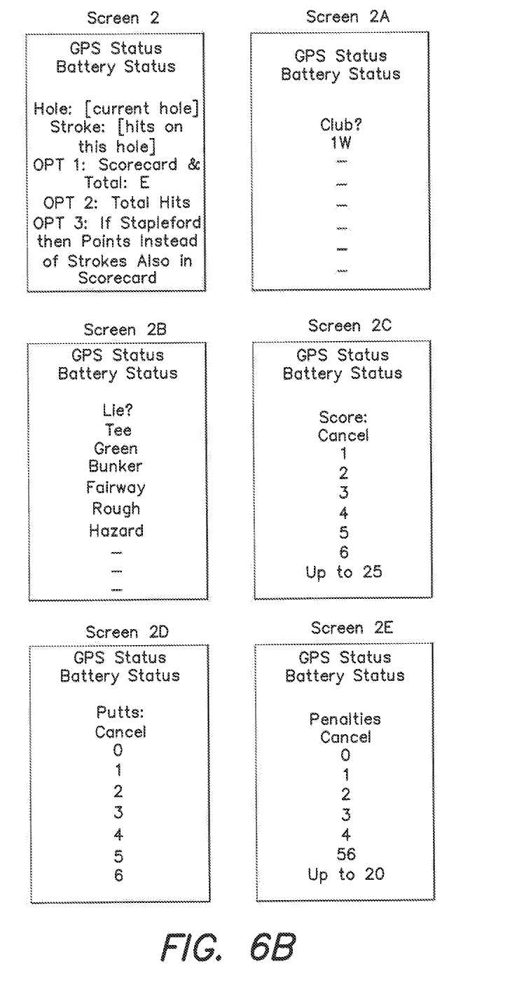

Referring now to FIGS. 6A and 6B, a conceptual flowchart illustrating an alternate golf-stroke recording process and corresponding conceptual screenshots are shown. In particular, the process includes presenting options to the player and receiving input from the player for recording golf strokes as the player traverses a hole and an entire round. In addition, the process includes utilizing location sensing functionality to identify the location of a player and/or the player's ball, and converting the received data into a scorecard that is sent to a centralized hosting server.

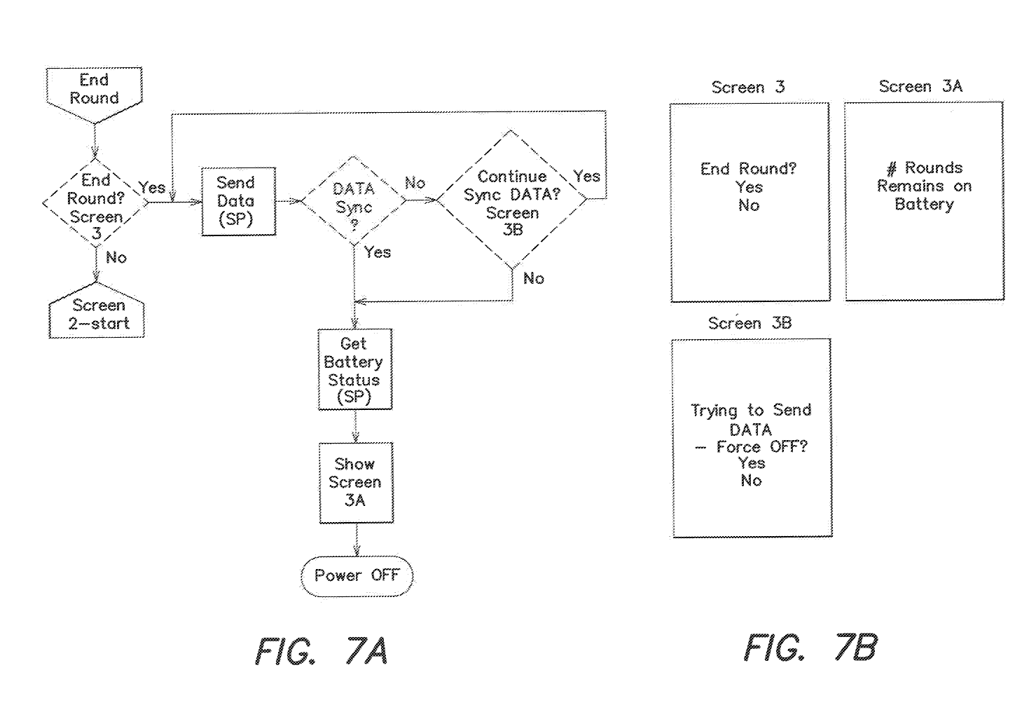

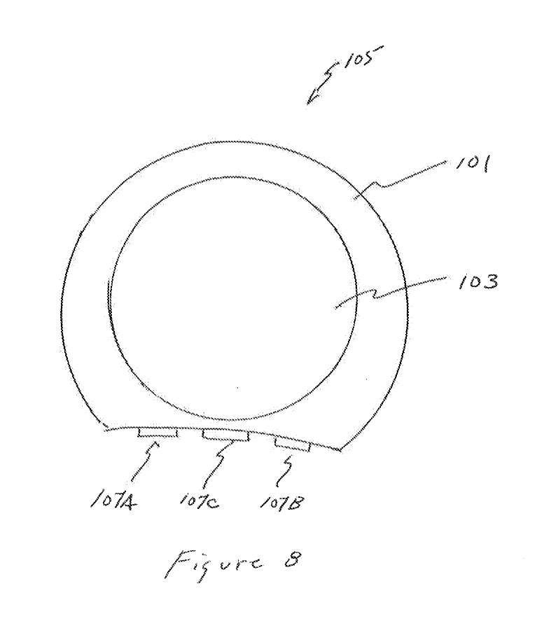

Referring now to FIGS. 7A and 7B, a conceptual flowchart illustrating a scorecard synchronization process and corresponding conceptual screenshots are shown. In particular, the process includes determining if the round has ended and uploading data associated with the round to the centralized server for recording.

FIG. 8 illustrates conceptually a user wearable apparatus 105 which may embody the golf-stroke recording system 100, described herein, including a processor 102, a memory 104 that is coupled to the processor 102 and a golf-stroke recording application 110 that includes one or more software modules for performing various operations described herein. As shown, the apparatus 105 may be relatively small for attachment to a user's garment, a half golf bag, or other accessory, and may include a display screen and one or more controls which, in the illustrative embodiment, may be implemented with a plurality of buttons. Specifically, the apparatus 105 may have a substantially circular shaped body 101 with a display screen 103 and on a first surface thereof for presenting data from the golfers scorecard, such as the whole number, current stroke count, distance, etc. in one embodiment, the perimeter of apparatus 105 includes an indented area in which a plurality of controls may be exposed, including a first or green button 107A by which the player may indicate that the ball is on a fairway, tee, or green and a second or red button 107B by which the player may indicate that the ball is not on a fairway, tee, or green. A neutral or activation button 1070 may also be present and may be depressed either preceding to or simultaneously with either the red or green button to prevent false inadvertent triggering of either the red or green button. In still other embodiments, only a single button may be utilized to initiate capturing of the GPS data describing the ball location.

In other embodiments, the apparatus 105 may be implemented with a personal digital assistant, such as an iPhone commercially available from Apple Computer, Cupertino Calif. or any number of commercially available personal digital assistants (PDAs) running the Android operating system, each of which may have the necessary hardware and software for acquiring GPS location data and interacting through their respective user interfaces with the user. In such implementation, the software modules for performing various operations of the golf-stroke recording application 110 described herein may be implemented in a software application specially designed for mobile devices and loadable thereon. It should be appreciated that the apparatus 105 may suffice as the device 20 shown in FIG. 1B.

Broadcast System

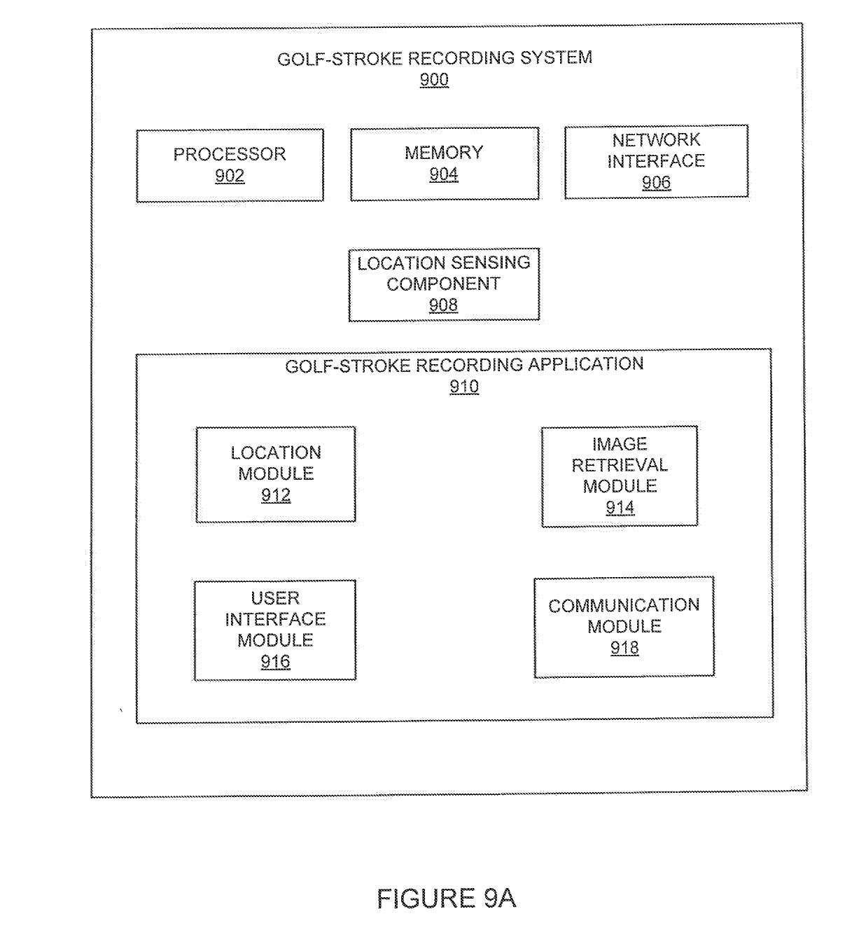

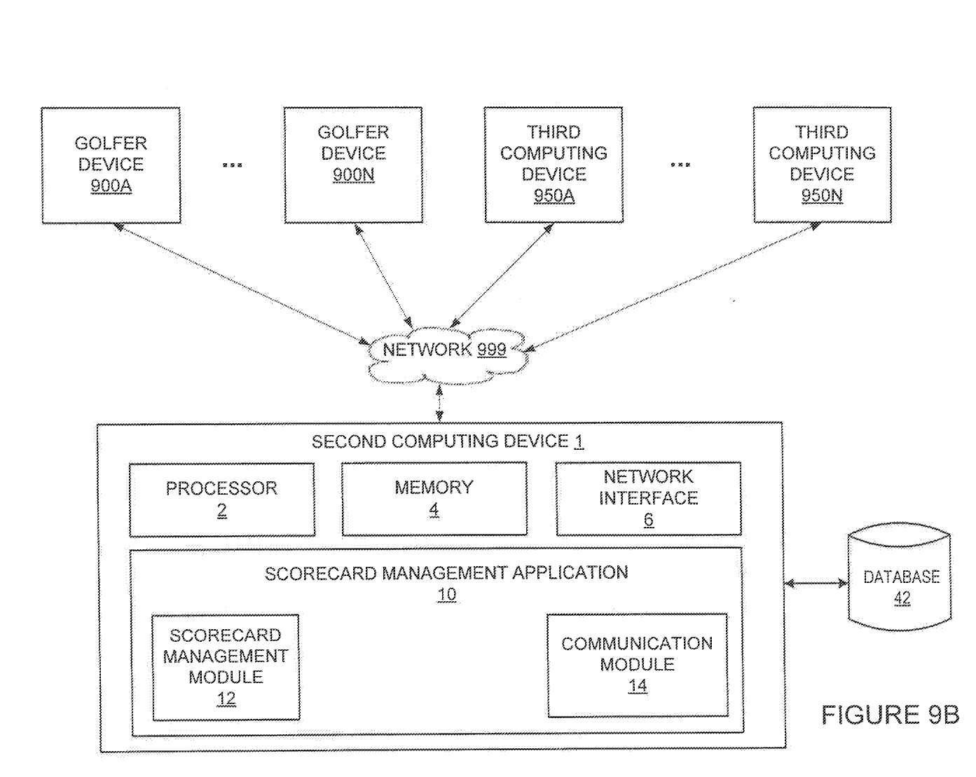

According to another aspect of the disclosed system, a method and system for broadcasting data related to a golfing event is disclosed herein. In particular, golfing event related data, which may include, scorecard information, player positions on a golf course, playing conditions, and the like may be broadcast to others via a central computing device. Referring now to FIGS. 9A, a conceptual block diagram of a first computing device configured to record golfing event related data for broadcasting is shown. The first computing device 900 may include a processor 902, a memory 904 coupled to the processor 902, and a network interface 906 coupled to the processor 902 and the memory 904. The first computing device 900 may further include a location sensing component 908 that is capable of acquiring location data, such as GPS satellite data. The first computing device 900 may further include an application 910 that is configured to include a location module 912 capable of acquiring location data relevant to a ball position and storing the location data in the memory 904. In some embodiments, the location module 912 may be configured to acquire the location data in response to user-initiated commands. Moreover, the application 910 may further include an image retrieval module 914 operably coupled to the network interface 906 and the location module 912, and may retrieve one or more satellite images from a network accessible source of satellite images associated with the ball position. In some embodiments, network accessible source of satellite images may be implemented with computer systems 60 or 70 illustrated in FIG. 1B.

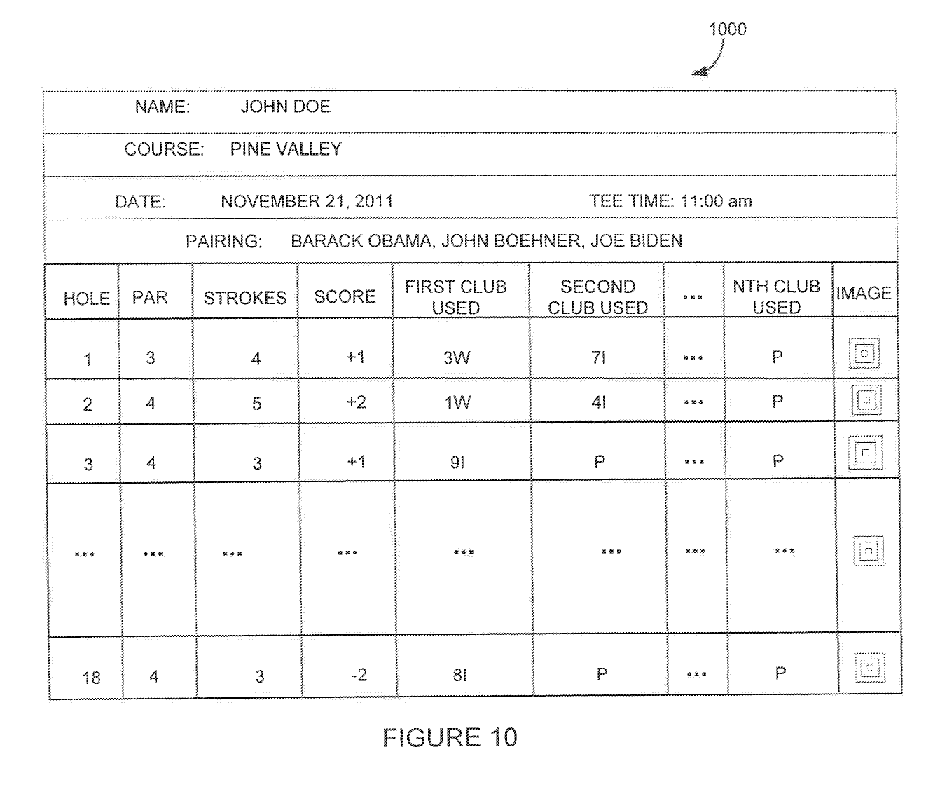

The first computing device 900 may further include a display engine, such as a user interface module 916 that is coupled to the memory 904 for generating a scorecard 1000 (shown in FIG. 10) that includes a visual representation of at least one ball position relative to the associated image, storing the generated scorecard in the memory 904, and for presenting the scorecard to a user of the first computing device 900. Moreover, the first computing device 900 may include a communication module 918 that is coupled to the memory 904 and the network interface 906 and configured to transmit the visual representation to another process over a communication network 999. If any of the embodiments of apparatus 105 may be utilized to implement first computing device 900.

The communication network 999 may be any type of network, including but not limited to, a LAN, a WAN, a WLAN, the Internet, or any other communication network through which remote computers may communicate with one another. As shown in FIG. 9B, a second computing device, such as a server computer 1, may be connected to the communication network 999 such that the second computing device 1 may be configured to communicate with the first computing device 900 via the communication network 999.

The second computing device 1 includes a processor 2 and a memory 4 coupled to the processor 2, that is configured to store a plurality of scorecards and data associated with the scorecards. In addition, the second computing device 1 includes a network interface 6 and a scorecard management application 10, which may include one or more software modules for providing specific functionality to the server computer 1. The scorecard management module 10 may include a scorecard management module 12 for managing scorecards stored in a storage location, such as the memory 4 or an internal or remote database 42. In addition, the scorecard management application 10 may include a communication module 14 that is coupled to the memory 4 and the network interface 6, that can transmit one or more of the scorecards stored in a storage location to other computing devices, including but not limited to the first computing device 900. In some embodiments, the second computing device 1 may be configured to receive requests for one or more scorecards 1000 from one or more of a plurality of computing devices, including the golfer devices 900A-N, and third computing devices 950A-N, and in response to such requests, the communication module 14 may transmit a desired scorecard to the computing device that submitted the request of the scorecard, if the profile of the scorecard owner provides authorizes access thereto.

As briefly mentioned above, the communication network 999 may be configured to allow other computing devices, such as the computing devices 950 to communicate with one or more of the first computing device 900 and the second computing device 1. In particular, the communication network 999 may be configured to allow the other computing devices 950 to send requests for data related to a golfing event, including but not limited to, requests for transmitting a scorecard and a present location of a player associated with the first computing device 900 on the golf course, to one or more of the first computing device 900 and the second computing device 1.

In some embodiments, the server computer 2 may be configured to manage communications and data transfer between any two of the first computing device, the server computer 2, and the third computing devices 950. In this way, the third computing devices 950 and the first computing devices may be configured to communicate indirectly with one another through the server computer 2 but may not be able to communicate directly without the server computer 2. Accordingly, the server computer 2 may serve as a gatekeeper for communications. In other embodiments, any two computing devices 900A-N may communicate strictly with each other in a peer-to-peer manner to exchange scorecard and location data, without the need for server computer to

The scorecard management module 10 of the server computer 2 may include a privacy module 16 that is configured to manage privacy settings of each of the golfers. Based on the privacy settings of the players, none, some, or all of the player's personal and golf-related data may be accessible to the third computing devices 950 other computing devices 900. In some embodiments, the players may be able to dictate which data can be shared and with whom the data can be shared. In this way, a golfer may share his scorecard only with people with friends who are a part of his social network, while others may not be able to access his scorecard.

Referring now to FIG. 10, a sample scorecard 1000 data structure is shown. The sample scorecard 1000 may include the golfer's name, a golf course at which the scorecard is associated, a date and time associated with the scorecard, and the group of golfers or pairing with which the golfer played the round. The scorecard may also include entries for each hole, including the associated par, the number of strokes the player took to finish the hole, his cumulative score, the types of clubs used for each of his strokes, and links to one or more images of the location from where the shot was hit relative to the hole, or the golf course, in general. In various embodiments, the images may include an aerial image indicating the general location of the ball relative to the hole, as well as an image of the ball relative to its immediate surroundings reflecting the lie of the ball. In some embodiments, the scorecard may also include information pertaining to the lie of the ball at each particular stroke. The information may be visually represented using colors or other visual graphics proximate to the type of club used for each shot. For instance, if the second shot of the first hole was made from a bad lie, the “7I” indicated in the scorecard may be shown in the color red. Similarly, if the second shot of the second hole was made from a good lie, the “4I” indicated in the scorecard may be shown in the color green.

In various embodiments of the present disclosure, a golf club detection module may be configured to determine which club a player is using to hit a particular stroke. As shown in FIG. 1B, the golf club detection module may include an electronic reader 25, such as an RFID tag reader or a bar code scanner, that is capable of identifying a particular club of the player. In such embodiments, each of the clubs 12 may contain an RFID tag 14 or be marked with a bar code. In the case of a barcode or their detectable graphic indicia, the player or his caddy may scan the club 12 before the player strike the ball with the particular club using the electronic reader 25, which may be manifested as either a handheld device or one located in the golf bag or golf cart. In the case of a club 12 containing an RFID tag 14, mere removal of the club from the golf bag may be sufficient to determine which club is being used to strike the ball. In addition, the golf club detection module may be configured to validate whether a particular club was used by calculating the distance the ball travelled with predetermined ranges assigned for each club. For instance, predetermined ranges for a wood may be defined to be longer than ranges defined for a sand wedge.

The golf club detection module may be implemented as a separate component that includes both hardware and software components. Alternatively, it may simply include an RFID reader that relays information to the first computing device 900 associated with the player, such that the application 910 may include a golf club detection software module that interfaces with the golf club detection module described above.

Exhibit 1 is a user manual describing aspects of the golf-stroke recording application according to one embodiment of the present disclosure. Exhibit 2 is a user manual describing additional aspects of the golf-stroke recording application according to one embodiment of the present disclosure. It should be appreciated that the scope of the present disclosure is not limited to the teachings disclosed in Exhibits 1 or 2 or the specific embodiments disclosed herein,

In addition, the disclosed system and technique should not be restricted to any specific implementations here described, for which other beneficial or alternate implementations may be substituted, in order to satisfy the organizational, functional or technology requirements imposed upon this disclosed system by any implementer. It will be apparent to those skilled in the art that modifications to the specific embodiments described herein may be made while still being within the spirit and scope of the teachings disclosed herein.

What is claimed is:

1. A golf-stroke recording system comprising:
a location sensing component,
a processor, and
a golf-stroke recording application executable by the processor, which is configured to track the movement of a player's golf ball as the golf ball traverses along the golf course, and then present the tracked movement of the golf ball on images associated with aerial views of the particular golf course on which the player is playing.

2. A system for broadcasting data related to a golfing event, comprising:
A) a first computing device comprising:
i) a processor,
ii) a memory coupled to the processor,
iii) a network interface coupled to the processor and memory,
iv) a location module, responsive to user-initiated commands, for acquiring GPS satellite data relevant to a ball position at a time the initiated command is received and for storing GPS satellite data associated with the ball position in the memory,
v) an image retrieval module, operably coupled to the network interface and the location module, for retrieving from a network accessible source of satellite images, an image associated with the ball position and for storing the image in memory,
vi) a display engine, coupled to the memory, for generating a scorecard comprising a visual representation of at least one ball position relative to the associated image and for storing the scorecard in memory and for presenting the scorecard to a user,
vii) communication module, coupled to the memory and the network interface, for transmitting the visual representation to another process over a communication network, and
B) a second computing device accessible over the communication network and configured for receiving and storing the scorecard from the first computing device. In one embodiment, the second computing device comprises a server apparatus having a memory configured for storing a plurality of different scorecards and communication module, coupled to the memory and a network interface, for transmitting the one of the plurality of scorecards stored in memory to a third computing device upon a request therefore.

3. In a computing apparatus having a processor coupled to a memory and a network interface operably coupling the processor and memory to a communication network, a method for broadcasting data related to a golfing event comprises:
A) receiving and storing into the memory a user-defined profile from each of a plurality of golfer processes, the plurality of profiles each identifying a golfer, network access information, and golfer privacy preferences;
B) receiving and storing into memory a scorecard associated with one of the plurality of golfers, the scorecard comprising data identifying any of a golf course_{;} a hole within the golf course, number of ball positions for a given hole, and a golf club for a shot; and
D) receiving a request from a remote process for a scorecard associated with one of the plurality of golfers;
E) determining from the golfer privacy preferences in the golfer profile associated with the requested scorecard if the scorecard is publishable; and
F) transmitting the identified scorecard to the remote process over a communication network if the scorecard is publishable.
